(19) United States
(12) Patent Application Publication
(10) Pub. No.: US 2012/0047022 A1
(43) Pub. Date: Feb. 23, 2012

(54) Providing Individualized Advertisement Based on Collaboratively Collected User Information

(76) Inventors: Shaukat Shamim, Santa Clara, CA (US); Rajat S. Shroff, Redwood Shores, CA (US); Armin G. Ebrahimi, San Jose, CA (US)

(21) Appl. No.: 13/216,041

(22) Filed: Aug. 23, 2011

Related U.S. Application Data
(60) Provisional application No. 61/375,994, filed on Aug. 23, 2010.

(51) Int. Cl. G06Q 30/02

(52) U.S. Cl. 705/14.66

(57) ABSTRACT

A collaborative advertising computer system and method for providing targeted advertisements to user client devices. The collaborative advertising computer system receives user activity reports, including browsing and purchasing data, from merchant computing systems. These user activity reports are used to infer the purchasing intentions of the users operating the user client devices. Based on these purchasing intentions, targeted advertisements are generated, and the advertisements are placed on content web pages displayed on the user client devices.

### CROSS-REFERENCE TO RELATED APPLICATIONS

This application claims the benefit of U.S. Provisional Application No. 61/375,994, filed Aug. 23, 2010, which is incorporated by reference herein.

### FIELD OF DISCLOSURE

The present disclosure relates generally to electronic commerce (e-commerce or ecommerce), and more particularly to providing customized advertisements through a collaborative advertising system.

### BACKGROUND

### Description of the Art

Selling goods and services through websites on the Internet has become commonplace. Merchants operating websites that offer goods and services for sale often place advertisements on other websites (web portals) in order to inform potential customers about their offerings, and to direct users to web pages where purchases can be made.

To make the advertisements displayed on a web portal more effective, it is desirable to tailor the advertisements based on information about the users viewing the advertisements. Information such as previous purchases made, items browsed on a merchant's website, advertisements clicked, etc., can be used to infer a user's interests in goods and services. This information can be used to provide better targeted advertisements that are tuned to a user's particular needs.

Unfortunately, a single merchant or web portal typically only has access to information about its own users, i.e., customers that have visited its websites. In addition, a single merchant or web portal can only capture user data concerning user actions on its own website. With such a small amount of data on users, a single merchant or web portal will not have much information about individual users, and it cannot effectively infer much, if anything, about the purchasing interests for that user.

Thus, there is lacking, inter alia, a way to collect user information from users of different merchant websites and different web portals and to collaboratively use the collected user information to serve targeted advertisements for any merchant on any web portal.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 is a high-level block diagram of a collaborative advertising system operating in a networked environment, according to one embodiment of the present disclosure.

FIG. 2 is a high-level block diagram illustrating an example computer.

FIG. 3 is a high-level block diagram illustrating a detailed view of modules within the collaborative advertising system according to one embodiment.

FIG. 4A and FIG. 4B are flow charts illustrating the operation of the collaborative advertising system according to one embodiment.

FIG. 5 is a ladder diagram illustrating a process for serving a targeted advertisement to a user according to one embodiment of the present invention.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

A system (and process) is configured to provide targeted advertisements to a user client device, operated by a user, through a collaborative advertising computer system. In one example embodiment, a system establishes a user data system including a plurality of behavioral profiles, where each behavioral profile is associated with a unique user identifier. The system receives from a merchant computing system, a recent user activity report for the user client device, and receiving from a web portal computing system a request for a targeted advertisement for the user client device. The system also receives a unique user identifier from the user client device, and retrieves a behavioral profile associated with the user client device from the user data system, using the received unique user identifier. The system generates an instantaneous purchasing profile for the user client device, where the instantaneous purchasing profile is generated using the recent user activity report and the retrieved behavioral profile. The system further provisions a targeted advertisement to the user client device based on the instantaneous purchasing profile.

### Overview of a Collaborative Advertising System

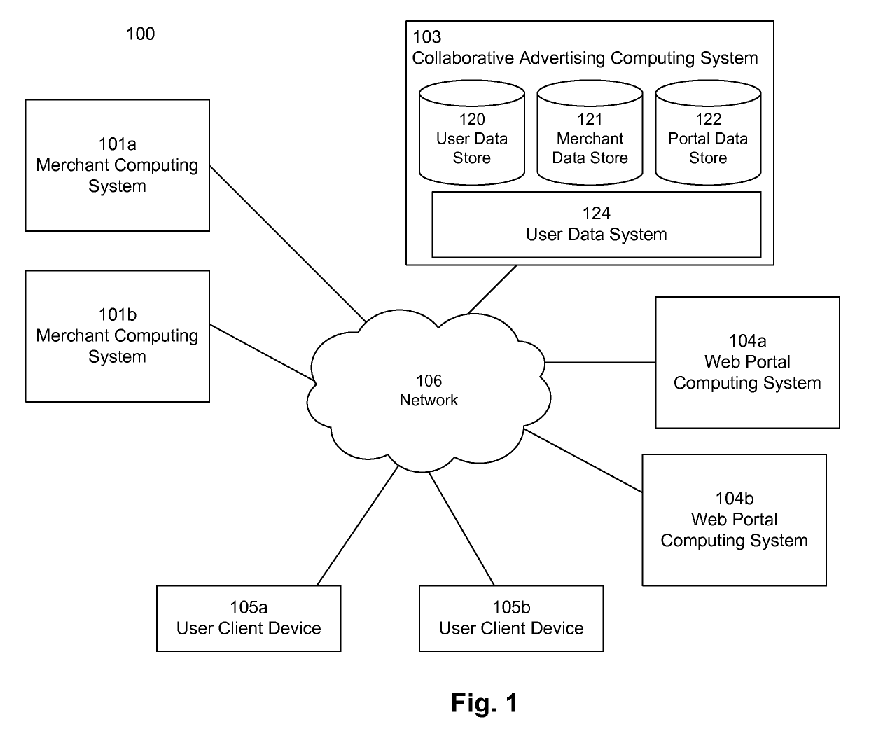

FIG. 1 is a high-level block diagram of an example embodiment of a collaborative advertising system 103 operating in a networked environment 100. One or more merchant computing systems 101a, 101b, etc. (generally 101), a collaborative advertising computing system 103, one or more web portal computing systems 104a, 104b, etc. (generally 104), and one or more user client devices 105a, 105b, etc. (generally 105) communicate via a network 106. In one embodiment, the systems 101, 103, 104 and client 105 are remote and independent of each other. As illustrated in FIG. 1 the networked environment 100 includes only a limited number of each entity, but the description herein will correspond to one of each entity for ease of understanding. However, it is understood the principle as disclosed herein would apply to a plurality of devices.

The network 106 is the Internet or another system of interconnected computer networks that use standard communications technologies and/or protocols to facilitate data transmission. Thus, the network 106 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 106 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 106 can be represented using technologies and/or formats including the hypertext markup language (HTML) and the extensible markup language (XML). In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above.

The merchant computing system 101 is used by a merchant to communicate with a user client device 105 operated by a human consumer. In one embodiment the merchant computing system 101 is a web server configured to send web pages to the user client device 105, for example, a computer server running the APACHE web server software, or other equivalent web server software. The merchant computing system may also be a virtual computing instance running in a data center, for example, a virtual computing instance running in AMAZON WEB SERVICES (AWS). The merchant computing system 101 accepts connections from user client devices and sends content—for example web pages—to the user client devices. By interacting with the merchant computing system 101, using the user client device 105, a consumer is able to browse the products and services offered by the merchant. The merchant computing system 101 also accepts orders for products and services from the user client device 105. An example of a merchant computing system 101 is a shopping website such as AMAZON.COM, or an auction website such as EBAY.COM.

The merchant computing system 101 is configured (e.g., programmed and/or functionally structured) to receive connections from user client devices that have been directed to it from advertisements placed on web pages hosted by web portal computing systems 104. When the merchant computing system 101 receives a connection from a user client device 105, through an advertisement, the merchant computing system 101 may provide a web page, containing information about a product or service, to the user client device 105. The provided web page may also allow the consumer operating the user client device 105 to place an order for a product or service.

The merchant computing system 101 may also provide a data stream to the collaborative advertising computing system 103, containing information and content related to the products and services that the merchant computing system 101 is offering for sale. The collaborative advertising computing system 103 may use this information and content to generate advertisements for the products and services offered for sale by the merchant computing system 101.

The merchant computing system 101 sends user activity reports to the collaborative advertising computing system 103. These user activity reports contain information about the browsing (e.g., viewing and interacting) and purchasing activities of the user client device 105, observed by the merchant computing system 101. The merchant computing system 101 reports the observed information along with other user client device information such as the network address (e.g., Internet Protocol (IP) address) to the collaborative advertising computing system 103. In addition, the merchant computing system 101 may enable the collaborative advertising computing system 103 to place a web browser cookie (called the “user identification cookie”) in the web browser executing on the user client device 105. This user identification cookie contains a unique user identifier, which is useful in identifying a given user client device across multiple sessions and multiple merchant computing systems and web portal computing systems. The merchant computing system 101 may also allow the web portal computing systems 104 and other merchant computing systems 101 to place web browser cookies (called “collaborative cookies”) in the web browser executing on the user client device 105. These collaborative cookies are used by web portal computing systems 104 and other merchant computing systems 101 to determine that a specific user client device 105 is tracked by the collaborative advertising computing system 103.

In one embodiment, the merchant computing system 101 includes in its web pages a segment of JAVASCRIPT code designed to cause the web browser executing on the user client device 105 to visit the web domain hosted by the collaborative advertising computing system 103, and thereby enables the collaborative advertising computing system to place the user identification cookie in the web browser executing on the user client device 105. The collaborative advertising computing system 103, in turn, may provide a segment of JAVASCRIPT code to the web browser executing on the user client device 105; this JAVASCRIPT code causes the user client device 105 web browser to visit the web domains of participating web portal computing systems and merchant computing systems 101, thereby enabling these participating computing systems to place their collaborative cookies in the user client device's web browser.

The web portal system 104 is used by an internet content provider to publish content on the network 106; the content may include one or more advertisements. The content may be web pages where the advertisements take the form of banner ads, pop-ups, and/or pop-unders. In one embodiment, the advertisements are hosted on the collaborative advertising computing system 103, and the web portal system 104 provides embedded links to the advertisements in its web pages. When the user client device 105 displays the web pages (e.g., through a browser application or applet), the links cause the advertisement content to be downloaded from the collaborative advertising computing system 103.

When sending content, such as a web page, to a user client device 105, the web portal computing system 104 may determine that the user client device 105 is one that is tracked by the collaborative advertising computing system 103. When this determination is made, the web portal computing system 104 may request that the collaborative advertising computing system 103 provide an advertisement targeted at the user client device 105, based on that user client device's past browsing and purchasing history as recorded in the collaborative advertising computing system 103. The web portal computing system 104 may provide additional information to the collaborative advertising system 103, in order to improve the targeting of the advertisement. The additional information may include the subject of the web page that the user client device 105 is displaying.

In order to make the determination that the user client device 105 is one that is tracked by the collaborative advertising computing system 103, the web portal computing system 104 may check for a “collaborative cookie” that was previously placed by that web portal computing system 104 in the web browser of the user client device 105. In addition, the web portal computing system 104 may place a segment of JAVASCRIPT code in its web page designed to cause the user client device web browser to visit the collaborative advertising computing system 103; this enables the collaborative advertising computing system 103 to retrieve the data in that user client device's user identifier cookie.

Although the web portal computing system 104 and the merchant computing system 101 are shown as distinct entities in FIG. 1, in some embodiments the same computing system may incorporate both a web portal computing system and a merchant computing system. For example, some shopping websites themselves host advertisements for their own products and for other merchants' products.

In one embodiment, the user client device 105 is an electronic device used by a human consumer to browse content on the web portal computing system 104, and to shop for products and services on the merchant computing system 101. The user client device 105 may be, for example, a desktop, laptop, or tablet computer, a mobile telephone, a set-top box, a dedicated electronic reader, or other form of electronic device with processing capability, and includes a web browser for viewing content received from the network 106. The consumer uses the user client device 105 to view and interact with the advertisements provided by the collaborative advertising computing system 103. The advertisements provided by the collaborative advertising computing system 103 may be presented on the user client device 105 as part of a web page provided by the web portal computing system 104. For example, the consumer may view a web page received from the web portal computing system 104 on the user client device 105, where the web page has a banner advertisement provided by the collaborative advertising computing system 103. By interacting with the advertisement provided by the collaborative advertising computing system 103, the user client device 105 may be directed to a web page hosted by the merchant computing system 101. Using the web page received from the merchant computing system 101, the consumer operating the user client device 105 may then place an order for a product or service offered by the merchant computing system 101.

The collaborative advertising computing system 103 receives information about the browsing and purchasing activities of user client devices 105—called user activity reports—from the merchant computing systems 101, and uses this information to provide targeted advertisements to the user client devices 105. In one embodiment these targeted advertisements are generated at the request of the web portal system 104, and are displayed on the user client device 105 as part of a web page provided by the web portal computing system 104.

The collaborative advertising computing system 103 collects user activity reports that contain browsing and purchasing information about the user client device 105, from the merchant computing system 101, and stores this information in the user data store 120. Using the information in the user data store 120, the collaborative advertising computing system 103 generates or updates a behavioral profile for the user client device 105 and stores the behavioral profile in the user data system 124. The behavior profile of the user client device 105 contains data which captures the historic purchases, browsing, and preferences of the consumer using the user client device 105.

The collaborative advertising computing system 103 may also receive data streams from the merchant computing system 101, where the data streams contain information and content about the products and services offered by the merchant computing system 101. This information and content is stored in the merchant data store 121. The collaborative advertising computing system 103 uses the information in the merchant data store 121 to generate advertisements for the user client device 105.

The collaborative advertising computing system 103 receives information from the web portal computing system 104 such as the subject matter and the position and size of advertising spaces on the web pages provided to the user client device 105. The collaborative advertising system 103 may store this information in the portal data store 122. This information is used when generating advertisements targeted for the user client device 105.

The collaborative advertising computing system 103 may also receive other information from the web portal computing system 104, such as user activity reports from the web portal concerning browsing activities of the user client device 105 on the web pages provided by the web portal computing system 104. These user activity reports may be stored in the user data store 120. This information may also be used to generate or update behavioral profiles stored in the user data system 124.

To generate an advertisement targeted at the user client device 105, the collaborative advertising computing system 103 retrieves the behavior profile in the user data system 124 that is associated with the user client device 105. Based on the behavior profile and the most recent received user activity reports for the user client device 105, the collaborative advertising computing system 103 generates an instantaneous purchasing profile for the user client device 105. The instantaneous purchasing profile is used to predict the entity, e.g., the product, category, brand, or merchant, that the consumer using user client device 105 would be most interested in. Using this information, the collaborative advertising computing system 103 retrieves content and information from the merchant data store 121 in order to construct an advertisement for this entity.

By way of example, the behavior profile of the user client device 105 and the most recent user activity reports concerning the user client device 105 may generate an instantaneous purchasing profile that indicates that the consumer using the user client device 105 is highly likely to buy NIKE running shoes. The collaborative advertising computing system 103 will then fetch content and information from the merchant data store 121 to generate an advertisement banner for NIKE running shoes, which links to a merchant computing system 101 (e.g., to a shopping website of a merchant) that offers the shoe for sale. This advertisement banner will be displayed as part of a web site (webpage provided by web portal computing system 104) displayed on user client device 105.

Because the collaborative advertising computing system 103 obtains user activity reports and other information from multiple different merchant computing systems 101 and multiple different web portal computing systems 104, the collaborative advertising computing system 103 has more information about a specific customer (who is using a user client device 105) than any other single merchant computing system or web portal computing system. In addition, the collaborative advertising system 103 may collect additional information from other sources such as social networking websites and product review websites. With all of this information the collaborative advertising computing system 103 has the most complete picture of a given consumer and can make the most accurately targeted advertisements for that consumer's user client device 105.

### Hardware Environment

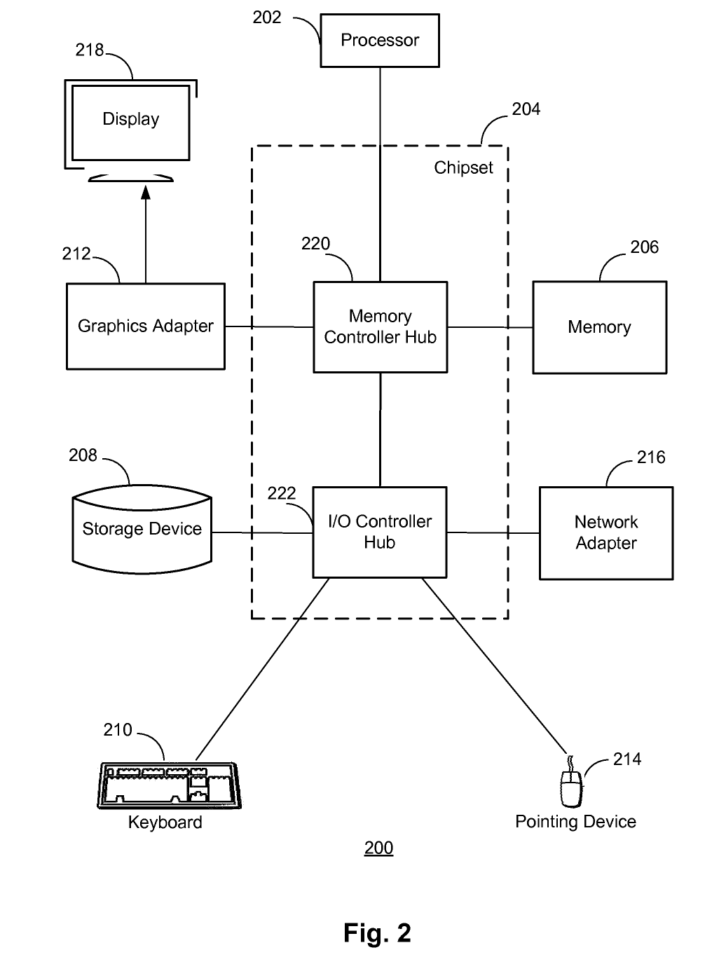

The entities shown in FIG. 1 are implemented using one or more computing devices with processing capability. FIG. 2 is a high-level block diagram illustrating an example computing device, e.g., computer 200. The computer 200 includes at least one processor 202 coupled to a chipset 204. The chipset 204 includes a memory controller hub 220 and an input/output (I/O) controller hub 222. A memory 206 and a graphics adapter 212 are coupled to the memory controller hub 220, and a display 218 is coupled to the graphics adapter 212. A storage device 208, keyboard 210, pointing device 214, and network adapter 216 are coupled to the I/O controller hub 222. Other embodiments of the computer 200 have different architectures.

The storage device 208 is a non-transitory computer-readable storage medium such as a hard drive, compact disk read-only memory (CD-ROM), DVD, or a solid-state memory device. The memory 206 holds instructions and data used by the processor 202. The pointing device 214 is a mouse, track ball, or other type of pointing device, and is used in combination with the keyboard 210 to input data into the computer 200. The graphics adapter 212 displays images and other information on the display 218. The network adapter 216 couples the computer 200 to one or more computer networks.

The computer 200 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 208, loaded into the memory 206, and executed by the processor 202.

The types of computers 200 used by the entities of FIG. 1 can vary depending upon the embodiment and the processing power required by the entity. For example, the collaborative advertising computing system 103 might comprise multiple blade servers working together to provide the functionality described herein. As another example, the user client 105 might comprise a smartphone with limited processing power. The computers 200 can lack some of the components described above, such as keyboards 210, graphics adapters 212, and displays 218. In addition, the collaborative advertising computing system 103 can run in a single computer 200 or multiple computers 200 communicating with each other through a network such as in a server farm.

### Collaborative Advertising Computing System

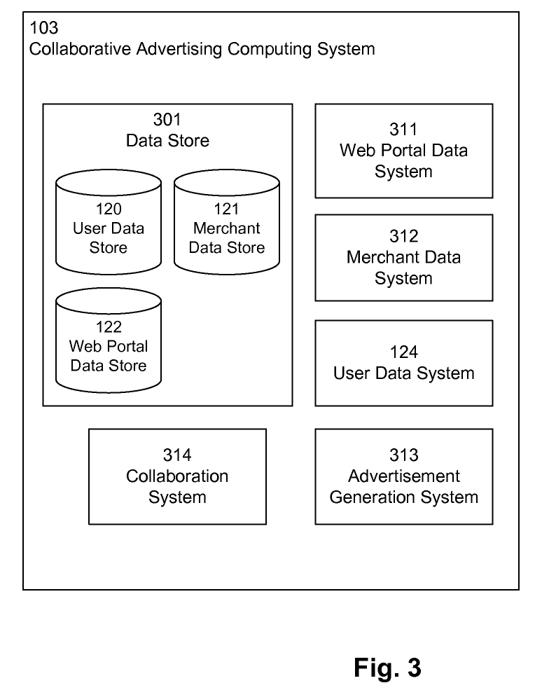

FIG. 3 is a high level block diagram showing an example embodiment of components of a collaborative advertising computing system 103. The collaborative advertising computing system 103 comprises a web portal data system 311, a merchant data system 312, an advertisement generation system 313, a collaboration system 314, a user data system 124, and a data store 301. The data store 301 includes the user data store 120, the merchant data store 121, and the web portal data store 122.

The merchant data system 312 receives data, through the network 106, from the merchant computing systems 101. Although FIG. 1 shows only two merchant computing system 101a and 101b, in practice there may be hundreds or thousands of such merchant computing systems communicating with the merchant data system 312. The merchant data system 312 receives user activity reports from the merchant computing systems 101. These user activity reports contain browsing and purchasing activities of a user through that user's user client device 105. The user activity reports are recorded by the merchant computing systems 101. The user activity reports may be stored in the user data store 120. The merchant data system 312 may also receive product and service data feeds from the merchant computing systems 101. These product and service data feeds provide information and content describing the products and services offered for sale by the merchant computing systems 101. The information includes details like price, category, brand, inventory, etc. The content includes things like product thumbnails, product photos, descriptions, product ratings etc. The information and content received through the feeds is stored in the merchant data store 121.

The user data system 124 is used by the collaborative advertising computing system 103 to determine the purchasing intentions of users that are using the one or more user client devices 105. The user data system 124 utilizes the information in the user data store 120, e.g., the information received from merchant computing systems 101 in the user activity reports, to generate behavior profiles for the one or more user client devices 105. A behavior profile contains the browsing (e.g., viewing and/or interacting) and purchasing history of a particular user through that user's user client device 105. The viewing and interacting history includes the user's views of, and interactions with advertisements. The behavior profile is identified by a unique user identifier. As the collaborative advertising computing system 103 receives user activity reports, the user data system 124 updates the existing behavior profiles.

The user data system 124 may also contain models, formulas, and rules used to determine a purchasing intention score for a product, category, brand, merchant, or any other entity. The purchasing intention score is a measure of the likelihood that the user operating the user client device 105 will be interested in purchasing something associated with that entity. For example, a high purchasing intention score for the brand ADIDAS indicates that the user operating the user client device is likely to purchase some item associated with that brand. The purchasing intention score is calculated using both the behavioral profile and the recent user activity reports for the user client device 105. The difference between a “recent” and “old” user activity report is not black and white, and the relevance of an activity report to the determination of purchasing intention can be based on a formula or a rule as opposed to all or nothing. In addition, the influence of old activity reports is still reflected in the behavioral profile for the user client device, since the behavioral profile is updated based on the user activity reports.

The purchasing intention score may be calculated or recalculated whenever a user activity takes place. A user activity can be any interaction with a website. Examples of user activities are viewing a product, clicking an advertisement link, and navigating to a new page. Each user activity may be reported to the collaborative advertising computing system 103 in a user activity report. These reported user activities can cause a change in the purchasing intention scores for the user client device 105. Additionally, each time an advertisement is presented to the user through the user client device 105, or when the user interacts with an advertisement displayed on the user client device 105, the purchasing intention score may be updated. However, the update of the purchasing intention score need not simply be based on the user activity that triggered the update; other parameters, such as time duration between events, and the relationship between the current event and prior events reported for the user client device 105 and other user client devices with similar behavioral profiles may also be taken into consideration when calculating a new purchasing intention score.

Using the purchasing intention scores, the user data system 124 is able to generate an instantaneous purchasing profile for any known user client device, given the unique user identifier stored in the user client device. The instantaneous purchasing profile for a user client device consists of a number of purchasing intention scores and the associated products, categories, brands, merchants, and other entities for those scores. For a given user client device, choosing the entity with the highest purchasing intention score gives the entity that the user has the most predicted “interest” in purchasing. The user operating the user client device is said to have an “expressed purchasing intention” towards that entity. Purchasing intention scores can also be generated for entities chained together, such as a purchasing intention score for a particular brand, of a particular product, from a particular merchant. For example, a purchasing intention score can be generated for a ROLEX/Watch/From AMAZON.COM. Often the expressed purchasing intention for a user will be for such a chain of entities because users generally want to buy a particular brand of a particular product, such as a SONY television, LEVI'S jeans, etc.

The web portal data system 311 receives information and requests from the web portal computing systems 104. Although FIG. 1 shows only two web portal computing systems 104a and 104b, in practice there may be hundreds or thousands of such web portal computing systems communicating with the web portal data system 311. The web portal data system 311 receives information from the web portal computing systems 104 regarding the subject matter of web pages sent to the user client devices 105, and the position and size of advertising space available on the web pages sent to the user client devices 105. The web portal data system 311 also receives requests from web portal computing systems for advertisements targeted at specific user client devices 105. The data received by the web portal data system 311 may be stored in the web portal data store 122, for later retrieval.

The advertisement generation system 313 generates targeted advertisements, for specific user client devices 105, based on requests from web portal computing systems 104, using the information in the user data system 124, merchant data store 121, user data store 120, and web portal data store 122. In order to generate a targeted advertisement for a user client device 105, the advertising generation system 313 first retrieves the unique user identifier stored in the user identifier cookie in the web browser executing on the user client device 105. The user identifier may be retrieved through the execution of a JAVASCRIPT segment embedded in a web page displayed in the web browser of the user client device 105.

Using the unique user identifier the advertising generation system 313 requests the instantaneous purchasing profile for the user client device 105 from the user data system 124. Based on the instantaneous purchasing profile, the advertising generation system 313 determines the entity (e.g., the product, category, merchant and/or brand) for which the user has expressed a purchasing intension. The advertisement generation system 313 can also be configured to obtain dimensions of a space available for the advertisement from either the web portal data store 122, or directly from the web portal computing system 104. Based on the purchasing intention, the advertising generation system 313 retrieves product information and content from the merchant data store 121, or directly from the data feed of the merchant computing system, and based on this content and information generates an advertisement. The advertisement is sent to the user client device 105, where it is displayed along with content from the web portal computing system. The advertisement, when activated, directs the user client device 105 to a web page for a participating merchant computing system.

The collaboration system 314 allows merchants operating merchant computing systems 101, and operators of web portal computing systems 104 to sign up for participation in the collaborative advertising system. The collaboration system 314 also receives notification from merchant computing systems 101 when advertisements lead to purchases. The collaboration system 314 can receive payments from the merchants for the referrals, for the purchases, or based on other terms. The collaboration system 314 may also send payments to web portal systems 104 based on advertisements placed on the web portal systems' web pages.

### Example Operation of Collaborative Advertising Computing System

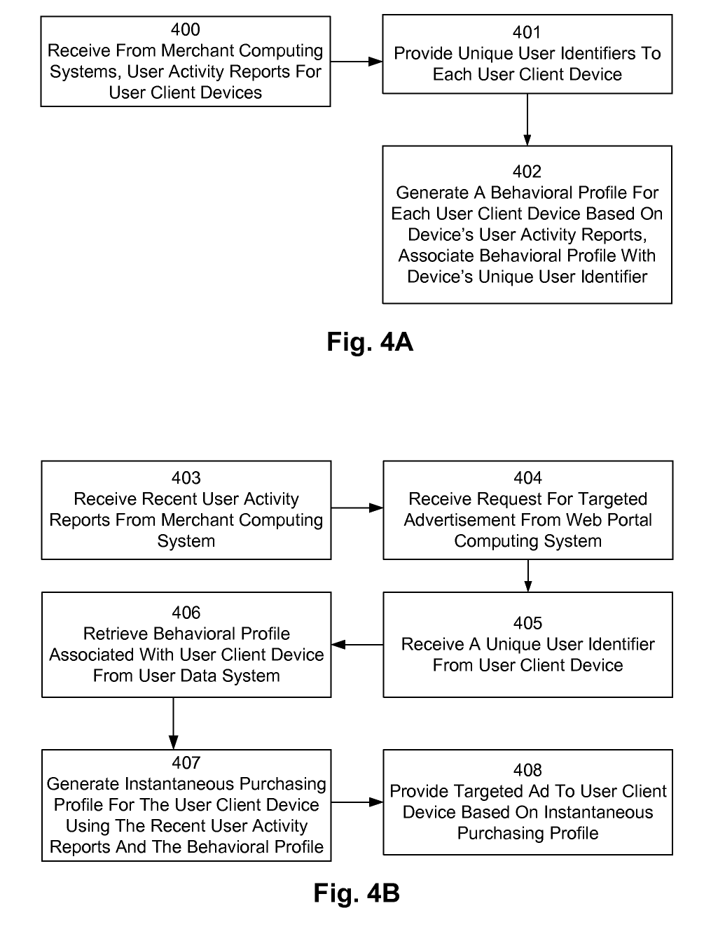

FIG. 4A illustrates the process for establishing the data in the user data system 124. The collaborative advertising computing system receives 400 user activity reports about one or more user client devices, from one or more merchant computing systems 101. The user activity reports contain the purchasing and browsing activities of the user client devices. The most recent user activity reports are the most relevant for the purpose of determining a user's purchasing intentions. The collaborative advertising computing system 103 provides 401 unique user identifiers to each user client device. The unique user identifiers may be stored on the user client devices 105 as cookies through web browsers running on the user client devices. The collaborative advertising computing system 103 generates 402 a behavioral profile for each user client device 105 based on the user activity reports received for that user client device. Each behavioral profile is associated with the unique user identifier of its user client device.

FIG. 4B illustrates the process for generating targeted advertisements for a user client device based on a behavior profile and recent user activity reports. The collaborative advertising system 103 receives 403 one or more recent user activity report from merchant computing systems. The collaborative advertising computing system 103 receives 404 a request for a targeted advertisement for a specific user client device, from a web portal computing system 104. The unique user identifier of the user client device is retrieved 405 from the user identifier cookie on the user client device 105. The behavioral profile associated with the unique user identifier is retrieved 406 from the user data system 124. This is the behavioral profile for the user client device 105. The collaborative advertising computing system 103 generates 407 an instantaneous purchasing profile for the user client device 105 based on the retrieved behavioral profile and the recent user activity reports. The collaborative advertising computing system 103 generates 408 a targeted advertisement based on the instantaneous purchasing profile, and provides the generated advertisement to the user client device 105.

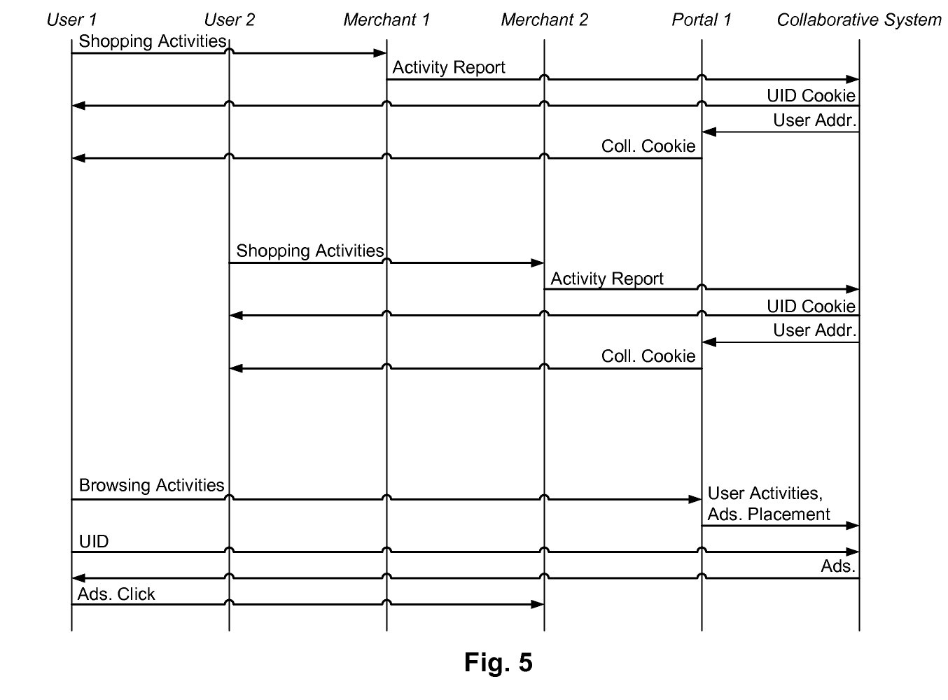

FIG. 5 is a ladder diagram illustrating one embodiment of an example process for a participating merchant computing system 101 to serve a targeted advertisement to a potential customer (using a user client device) in an environment with several user client devices 105 and several merchant computing systems 101. As shown, a first user using a user client device (“user 1” in FIG. 5) visits a first participating merchant computing system (“merchant 1” in FIG. 5) to perform some user activities such as browsing or purchasing an item or a service. The first participating merchant computing system reports the user activities to the collaborative advertising computing system 103 (“Collaborative System” in FIG. 5) in a user activity report (“Activity Report” in FIG. 5), and enables the collaborative advertising computing system 103 to place a user identifier cookie (“UID Cookie” in FIG. 5) in the first user client device's browser, where the user identifier cookie contains a unique user identifier for the user client device.

The collaborative advertising computing system 103 stores the user activity report in the user data store 120, and updates (or creates) a behavioral profile associated with the unique user identifier in the user data system 124. The collaborative advertising computing system 103 also notifies a participating web portal computing system (“portal 1” in FIG. 5) about the first user client device, and enables the web portal computing system to place its own collaborative cookie (“Coll. Cookie” in FIG. 5) in the first user client device's browser.

Subsequently, a second user client device (“user 2” in FIG. 5) visits a second participating merchant computing system (“merchant 2” in FIG. 5) to perform some user activities such as browsing and purchasing an item or a service. As described above, the second participating merchant computing system reports the observed user activities to the collaborative advertising computing system 103. The collaborative advertising computing system 103 places a user identifier cookie, containing a unique user identifier, in the second user client device's web browser, and the participating web portal computing system places a collaborative cookie in the second user client device's web browser. The collaborative advertising computing system 103 stores the user activity report in the user data store 120, and updates (or creates) a behavioral profile associated with the unique user identifier in the user data system 124. At this point, the first user client device has not interacted with the second merchant computing system, and the second user client device has not interacted with the first merchant computing system.

The first user client device subsequently connects to the web portal computing system and performs some browsing activities. The web portal computing system detects the presence of its collaborative cookie in the first user client device's web browser and thus determines that the first user client device is known to the collaborative advertising computing system 103. As a result, the web portal computing system notifies the collaborative advertising computing system 103 of the connection by the first user client device, and transmits the observed user activities along with advertisement placement information to the collaborative advertising computing system. The collaborative advertising computing system 103 identifies the first user client device based on the unique user identifier in the user identifier cookie residing in the first user client device's web browser. The system 103 retrieves the behavioral profile associated with that user identifier from the user data system 124 and the recent user activity report received from the first merchant computing system stored in the user data store 120.

The collaborative advertising computing system 103 generates an instantaneous purchasing profile for the first user client device based on the retrieved information. The collaborative advertising computing system 103 also determines that the second merchant computing system is the most likely entity to close a sale with the user operating the first user client device. The collaborative advertising computing system 103 generates an advertisement for the second merchant computing system matching this inferred user intent, and serves the generated advertisement to the first user client device through the content web page displayed in the web browser of the first user client device. Because it is likely that the advertisement matches the intent of the user operating the first user client device, the user clicks on (or otherwise activates) the advertisement and is redirected to the second merchant computing system.

Thus by collecting customer information from many participating sources and domains, the collaborative advertising system beneficially builds a large database of customer information for customers of many participating sources. The collaborative advertising computing system 103 can infer a customer's intent based on information collected for that customer and generate an advertisement that is likely to lead to a purchase by that customer.

The embodiments disclosed herein beneficially aggregate information about users' purchasing and browsing habits to provide advertisements on the user client devices 105 that help those users find the products and services that they are most likely to purchase. Example embodiments disclosed herein also beneficially provide merchant websites (merchant computing systems 101) with high quality user traffic, through advertising links, where the visiting users are highly likely to make a purchase. Further, the disclosed embodiments are able to generate tangible advertisements and electronically deliver them to specific user client devices based on prior electronic browsing and purchasing experiences of the users.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for collaboratively collecting customer information and providing individualized advertisements. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus disclosed herein.

What is claimed is:

1. A method for providing targeted advertisements to a user client device, operated by a user, through a collaborative advertising computing system, comprising:
establishing a user data system including a plurality of behavioral profiles, each behavioral profile associated with a unique user identifier;
receiving, from a merchant computing system, a recent user activity report for the user client device;
receiving, from a web portal computing system, a request for a targeted advertisement for the user client device;
receiving a unique user identifier from the user client device;
retrieving a behavioral profile associated with the user client device, from the user data system, using the received unique user identifier;
generating an instantaneous purchasing profile for the user client device, the instantaneous purchasing profile generated using the recent user activity report and the retrieved behavioral profile; and
providing a targeted advertisement to the user client device based on the instantaneous purchasing profile.

2. The method of claim 1, wherein establishing a user data system comprises:
receiving, from a plurality of merchant computing systems, a plurality of user activity reports, each user activity report associated with one of a plurality of user client devices;
providing a unique user identifier to each user client device in the plurality of user client devices; and
generating, for each user client device in the plurality of user client devices, a behavioral profile based on the user activity reports associated with that user client device, and associating each generated behavioral profile with the unique user identifier of that user client device.

3. The method of claim 2, wherein the plurality of user activity reports comprise the viewing, interacting, and purchasing activities of the plurality of user client devices, while browsing content and advertisements, while connected to the plurality of merchant computing systems.

4. The method of claim 2, where providing a unique user identifier to each user client device in the plurality of user client devices further comprises causing a cookie to be stored through a web browser running on each user client device, each cookie including the unique user identifier of that user client device.

5. The method of claim 1, wherein the recent user activity report comprises the viewing, interacting, and purchasing activities of the user client device, while browsing content and advertisements, while connected to the merchant computing system.

6. The method of claim 1, where providing a targeted advertisement further comprises:
determining, based on the instantaneous purchasing profile, an entity for which the user has expressed a purchasing intention;
responsive to the determination of the entity, generating an entity advertisement; and
providing the generated entity advertisement to the user client device.

7. The method of claim 6, wherein:
the instantaneous purchasing profile comprises a plurality of purchasing intention scores, each purchasing intention score associated with a product, and each purchasing intention score a measure of the likelihood that the user will purchase the associated product; and
the step of determining an entity for which the user has expressed a purchasing intention, further comprises, determining the product associated with the highest purchasing intention score.

8. The method of claim 6, wherein:
the instantaneous purchasing profile comprises a plurality of purchasing intention scores, each purchasing intention score associated with a category, and each purchasing intention score a measure of the likelihood that the user will purchase a product in the associated category; and
the step of determining an entity for which the user has expressed a purchasing intention, further comprises, determining the category associated with the highest purchasing intention score.

9. The method of claim 6, wherein:
the instantaneous purchasing profile comprises a plurality of purchasing intention scores, each purchasing intention score associated with a merchant computing system, and each purchasing intention score a measure of the likelihood that the user will purchase a product from the associated merchant computing system; and
the step of determining an entity for which the user has expressed a purchasing intention, further comprises determining the merchant computing system associated with the highest purchasing intention score.

10. The method of claim 1, further comprising updating data in the user data system using data in the recent user activity report.

11. The method of claim 1, wherein the targeted advertisement directs the user client device to a merchant computing system that is different from the merchant computing system that provided the recent user activity report.

12. A computing device having a memory and processor, the memory storing instructions that when executed cause the processor to:
establish a user data system including a plurality of behavioral profiles, each behavioral profile associated with a unique user identifier;
receive, from a merchant computing system, a recent user activity report for the user client device;
receive, from a web portal computing system, a request for a targeted advertisement for the user client device;
receive a unique user identifier from the user client device;
retrieve a behavioral profile associated with the user client device, from the user data system, using the received unique user identifier;
generate an instantaneous purchasing profile for the user client device, the instantaneous purchasing profile generated using the recent user activity report and the retrieved behavioral profile; and
provide a targeted advertisement to the user client device based on the instantaneous purchasing profile.

13. The computing device of claim 12, wherein the memory storing instructions to establish a user data system, further comprises instructions that when executed cause the processor to:
receive, from a plurality of merchant computing systems, a plurality of user activity reports, each user activity report associated with one of a plurality of user client devices;
provide a unique user identifier to each user client device in the plurality of user client devices; and
generate, for each user client device in the plurality of user client devices, a behavioral profile based on the user activity reports associated with that user client device, and associating each generated behavioral profile with the unique user identifier of that user client device.

14. The computing device of claim 13, wherein the plurality of user activity reports comprise the viewing, interacting, and purchasing activities of the plurality of user client devices, while browsing content and advertisements, while connected to the plurality of merchant computing systems.

15. The computing device of claim 13, where the memory storing instructions to provide a unique user identifier to each user client device in the plurality of user client devices further comprises instructions that when executed cause the processor to:
cause a cookie to be stored through a web browser running on each user client device, each cookie including the unique user identifier of that user client device.

16. The computing device of claim 12, wherein the memory storing instructions to provide a targeted advertisement, further comprises instructions that when executed cause the processor to:
determine, based on the instantaneous purchasing profile, an entity for which the user has expressed a purchasing intention;
responsive to the determination of the entity, generate an entity advertisement; and
provide the generated entity advertisement to the user client device.

17. A collaborative advertising system comprising a computer processor and a computer-readable storage medium storing computer program modules configured to execute on the computer processor, the computer program modules comprising an application configured to:
establish a user data system including a plurality of behavioral profiles, each behavioral profile associated with a unique user identifier;
receive, from a merchant computing system, a recent user activity report for the user client device;
receive, from a web portal computing system, a request for a targeted advertisement for the user client device;
receive a unique user identifier from the user client device;
retrieve a behavioral profile associated with the user client device, from the user data system, using the received unique user identifier;
generate an instantaneous purchasing profile for the user client device, the instantaneous purchasing profile generated using the recent user activity report and the retrieved behavioral profile; and
provide a targeted advertisement to the user client device based on the instantaneous purchasing profile.

18. The collaborative advertising system of claim 17, wherein the application configured to establish a user data system is further configured to:
receive, from a plurality of merchant computing systems, a plurality of user activity reports, each user activity report associated with one of a plurality of user client devices;
provide a unique user identifier to each user client device in the plurality of user client devices; and
generate, for each user client device in the plurality of user client devices, a behavioral profile based on the user activity reports associated with that user client device, and associating each generated behavioral profile with the unique user identifier of that user client device.

19. The collaborative advertising system of claim 18, wherein the plurality of user activity reports comprise the viewing, interacting, and purchasing activities of the plurality of user client devices, while browsing content and advertisements, while connected to the plurality of merchant computing systems.

20. The collaborative advertising system of claim 18, where the application configured to provide a unique user identifier to each user client device in the plurality of user client devices is further configured to:
cause a cookie to be stored through a web browser running on each user client device, each cookie including the unique user identifier of that user client device.

21. The collaborative advertising system of claim 17, wherein the application configured to provide a targeted advertisement, is further configured to:
determine, based on the instantaneous purchasing profile, an entity for which the user has expressed a purchasing intention;
responsive to the determination of the entity, generate an entity advertisement; and
provide the generated entity advertisement to the user client device.
